(19) United States
(12) Patent Application Publication
(10) Pub. No.: US 2025/0265155 A1
(43) Pub. Date: Aug. 21, 2025

(54) AGENT-BASED REBOOT INTERFACE SELECTION AND IMPLEMENTATION

(71) Applicant: Ivanti, Inc., South Jordan, UT (US)

(72) Inventor: Mark Tempel, New Brighton, MN (US)

(73) Assignee: Ivanti, Inc., South Jordan, UT (US)

(21) Appl. No.: 19/057,839

(22) Filed: Feb. 19, 2025

Related U.S. Application Data
(60) Provisional application No. 63/555,826, filed on Feb. 20, 2024.

(51) Int. Cl. G06F 11/14; G06F 8/65; G06F 9/4401

(52) U.S. Cl. CPC G06F 11/1417; G06F 8/65; G06F 9/4401

(57) ABSTRACT

A method of automated software management may include: identifying, at an agent located on the managed endpoint, a reboot policy in which the reboot policy may indicate one or more reboot behaviors initiated after update operations are performed at the managed endpoint; identifying, at the agent, a first update operation associated with a first level of criticality based on metadata associated with an instruction implemented to locally perform the first update operation on the managed endpoint; comparing, at the agent, the first level of criticality of the first update operation with the reboot policy to determine a first reboot behavior; and transitioning, at the agent, an endpoint state to a first reboot state to actuate the first reboot behavior in which the first reboot state comprises one or more of an advised reboot state, a mandatory reboot state, or a critical reboot state.

### CROSS REFERENCE TO RELATED APPLICATION

This application claims priority to and the benefit of U.S. Provisional Application No. 63/555,826 filed Feb. 20, 2024, which is incorporated herein by reference in its entirety.

### FIELD

The examples described in this disclosure are related to agent-based reboot interface selection and implementation, and in particular to agent-based interface selection and implementation of managed endpoints.

### BACKGROUND

In enterprise and other managed networks, an endpoint refers to a computing device that is integrated into the network and that is in communication with a management device. The management device may include a server device, for instance, which has visibility to operating parameters and state parameters of the endpoints. Based on information communicated between the management device and the endpoints, the management device may detect issues at the endpoints, deploy solutions to the endpoints, update software on the endpoints, troubleshoot issues at the endpoints, provision roles and security controls to the endpoints, and the like.

One element of the managed networks is coordination and distribution of product updates. Sometimes this operation is referred to as patch management. The updates or patches include code changes to products on the managed endpoints or some subset thereof. The products that are updated include software applications, software tools, operating systems, and the like. Distribution of the updates is performed to ensure the products are properly functioning and to ensure cybersecurity vulnerabilities are addressed.

In some circumstances, a vendor publicizes the updates that are relevant to its products. Publication of the updates is an ongoing process. For instance, MICROSOFT® has traditionally released software patches on “Patch Tuesday” which occurs on the second and sometimes the fourth Tuesday of each month. In addition, software patches might be released and published responsive to detection of a specific vulnerability. Following publication of the software patches, administrators of the managed networks may access and distribute the product updates.

The managed networks sometimes include one or more endpoints that are not entirely controlled by an administrator of the managed network. For instance, some managed networks may support a bring your own device (BYOD) environment or may include an extensive network of devices and users having distinct roles. The managed network that supports the BYOD environment may allow a user or an employee to use a personal endpoint. Accordingly, the products loaded on the personal endpoint may not be known or controlled by the administrator of the managed network. Similarly, an extensive network may include endpoints that use different and non-standard product inventories. In these and other managed networks, it is difficult to properly and efficiently manage updates. Accordingly, some products may persist in an un-patched or out-of-date state. Thus, there is a need to improve the product update management systems and processes.

The subject matter claimed herein is not limited to examples that solve any disadvantages or that operate only in environments such as those described. Rather, this background is only provided to illustrate one example technology area where some examples described herein may be practiced.

### SUMMARY

According to an aspect of the invention, an embodiment includes a method of automated software management of a managed endpoint. The method may include identifying, at an agent located on the managed endpoint, a reboot policy. The reboot policy may indicate one or more reboot behaviors initiated after update operations are performed at the managed endpoint. The method may include identifying, at the agent, a first update operation associated with a first level of criticality based on metadata associated with an instruction implemented to locally perform the first update operation on the managed endpoint. The method may include comparing, at the agent, the first level of criticality of the first update operation with the reboot policy to determine a first reboot behavior. The method may include transitioning, at the agent, an endpoint state to a first reboot state to actuate the first reboot behavior. The first reboot state may include one or more of an advised reboot state, a mandatory reboot state, or a critical reboot state. The method may include actuating, at the agent, the first reboot behavior using the first reboot state.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Examples will be described and explained with additional specificity and detail through the use of the accompanying drawings in which:

FIG. 1 depicts a block diagram of an example operating environment in which embodiments of the present disclosure may be implemented;

FIG. 2A depicts a block diagram of a first example automated software management process that may be implemented in the operating environment of FIG. 1;

FIG. 2B depicts a block diagram of a second example automated software management process that may be implemented in the operating environment of FIG. 1;

FIG. 2C is a block diagram of a third automated software management process that may be implemented in the operating environment of FIG. 1;

FIG. 3 is an example state diagram that may be implemented in the processes of FIGS. 2A-2C;

FIG. 4 is a block diagram of an example endpoint that may be implemented in the operating environment of FIG. 1 and the processes of FIGS. 2A-2C;

FIG. 5A is a first timing diagram of an example policy communication operation that may be implemented in the operating environment of FIG. 1 and the processes of FIGS. 2A-2C;

FIG. 5B is a second timing diagram of reboot prioritization that may be implemented in the operating environment of FIG. 1 and the processes of FIGS. 2A-2C;

FIG. 6 is a block diagram of a display having information about one or more reboot options of the processes of FIGS. 2A-2C;

FIG. 7 illustrates an automated software management process that may be implemented in the operating environment of FIG. 1;

FIG. 8 illustrates an example computer system configured for automated software management; and

FIGS. 9A-9D are a flow chart of an example method of automated software management, all according to at least one example described in the present disclosure.

### DESCRIPTION OF SOME EXAMPLE EMBODIMENTS

The examples described in this disclosure are related to automated endpoint product management. Some examples provide endpoint product management using agent-based reboot interface selection and implementation of managed endpoints (hereinafter, endpoint or managed endpoint”).

For instance, software-as-a-service (SAAS) endpoint management may involve communication between a management device, one or more endpoints, an admin device, and a third-party server. The management device may employ agents deployed on the endpoints. The agents may include engines that control aspects of the management of the endpoints. The management device may enable an administrator to create client-specific policies and settings.

In these and other managed networks, it is difficult to properly and efficiently manage updates. For example, when there is an update (e.g., a patch or a software change) made at the endpoints, the system may be rebooted to finalize installation and enable use or the update. In managed networks with thousands of endpoints, rebooting every system at the same time may interfere with the operations. On the other hand, allowing vulnerabilities to persist on the endpoints for a long period of time increases security risks. Accordingly, there is a tradeoff between risk (e.g., the risk of the vulnerability) and intervention and/or delay caused by the reboot. Furthermore, for an agent with multiple engines, there may be multiple commands that may not operate properly without a reboot. Therefore, the multiple commands on the multiple engines may pose a risk of an outstanding vulnerability when the multiple commands are not prioritized and/or aggregated to manage the risk.

The embodiments described herein include systems and methods configured to automated management of outstanding reboot operations following update operations. For example, an embodiment may include identifying, at an agent located on the endpoint, a reboot policy. The reboot policy may indicate one or more reboot behaviors initiated after update operations are performed at the endpoint. Another operation may include identifying, at the agent, a first update operation associated with a first level of criticality based on metadata associated with an instruction implemented to locally perform the first update operation on the endpoint. Another operation may include comparing, at the agent, the first level of criticality of the first update operation with the reboot policy to determine a first reboot behavior. Another operation may include transitioning, at the agent, an endpoint state to a first reboot state to actuate the first reboot behavior in which the first reboot state comprises one or more of an advised reboot state, a mandatory reboot state, or a critical reboot state. Another operation may include actuating, at the agent, the first reboot behavior using the first reboot state.

Automated software management of an endpoint (e.g., using a reboot policy) may: (a) minimize and reduce reboots at the endpoints which may reduce interruptions on the endpoint, e.g., to a user, (b) enable control of the reboot at the endpoint based on a central policy, and (c) reduce the amount of time that vulnerabilities persist on the endpoints.

Accordingly, examples of the present disclosure are directed at a computer-centric problem and are implemented in a computer-centric environment. For instance, the examples of the present disclosure are directed to product update management in the managed network 110. Computing processes occurring in the operating environment 100 include communication and implementation of product updates that include software patches and code changes on products loaded on the endpoints 106. Communications during the processes described in this present disclosure involve the communication of data in electronic and optical forms via a network 120 and also involve the electrical and optical interpretation of the data and information.

Furthermore, the examples of the present disclosure address a technical issue that exists in a technical environment. The technical issue includes an inability of conventional patch management systems to manage product updates based on products at the endpoints 106 and the inefficiencies that result therefrom. The technical problem is solved through a technical solution. For instance, the technical solution involves: (i) identifying a reboot policy in which the reboot policy may indicate one or more reboot behaviors initiated after update operations are performed at the endpoint; (ii) identifying a first update operation associated with a first level of criticality based on metadata associated with an instruction implemented to locally perform the first update operation on the endpoint; (iii) comparing the first level of criticality of the first update operation with the reboot policy to determine a first reboot behavior, (iv) transitioning an endpoint state to a first reboot state to actuate the first reboot behavior in which the first reboot state comprises one or more of an advised reboot state, a mandatory reboot state, or a critical reboot state, and (v) actuating the first reboot behavior using the first reboot state.

These and other examples are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures is not intended to limit the scope of the systems and methods, as claimed, but is merely representative of example configurations of the systems and methods.

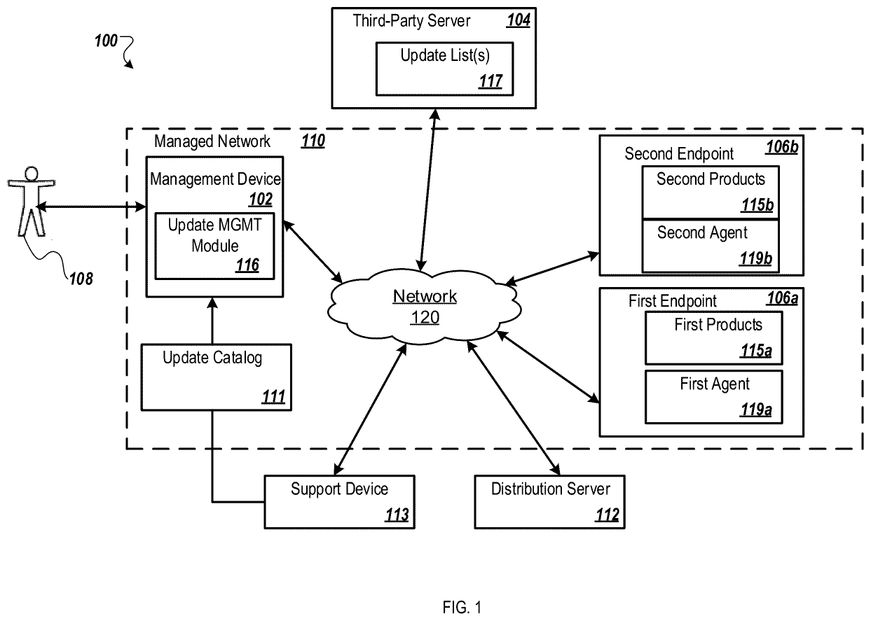

FIG. 1 is a block diagram of an example operating environment 100 in which some examples of the present disclosure can be implemented. The operating environment 100 is configured for implementation of automated software management of an endpoint. The operating environment 100 may include the managed network 110, a third-party server 104, a support device 113, and a distribution server 112. The managed network 110 includes the management device 102 that may communicate with the third-party server 104, the support device 113, the endpoints 106, and the distribution server 112 via a network 120. The components of the operating environment 100 are configured to communicate data and information via the network 120 to perform automated endpoint product management as described in the present disclosure. Each of these components are described below.

The network 120 may include any communication network configured for communication of signals between the components (e.g., 102, 113, 112, 104, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Instcon® communication network, an EnOccan® communication network, a Wi-Fi communication network, a ZigBee communication network, a representative state transfer application program interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The third-party server 104 includes a hardware-based computer device or collection thereof that is configured to communicate with the other components of the operating environment 100 via the network 120. The third-party server 104 is configured to provide access to one or more update lists 117, portions thereof, and information pertaining to entries of the update lists 117. For instance, the third-party server 104 may host a website on which the update lists 117 are available. The third-party server 104 may host or store the update lists 117 such that information, metadata, and data related to entries on the update lists 117 may be accessed via the network 120. For instance, the management device 102 or the support device 113 may be configured to access the update lists 117 or information related to entries on the update lists 117 via the network 120. In some examples, the management device 102 or the support device 113 may be configured to communicate an electronic message to the third-party server 104 that accesses the update lists 117, information (e.g., update metadata) related to entries on the update lists 117, or a specific portion of the update lists 117. Some examples of example application programming interfaces (APIs) for accessing the update lists 117 are available at https://www.circl.lu/services/cve-search/.

The update lists 117 may include a list of entries. The entries relate to a cybersecurity threat, a cybersecurity vulnerability, a software application code change, a patch, a hardware interface modification, or another update to a product. The entries have information related to the entries. For instance, one or more of the entries may include an identification number, an entry date, an entry summary, a links to product updates (e.g., a code change or patch), a threat severity, or some combination thereof.

An example of the third-party server 104 may be Department of Homeland Security (DHS) server(s). In this example, the update lists 117 may include lists of common vulnerabilities and exposures (CVEs) hosted by the DHS servers. Another example of the third-party server 104 may be National Institute of Standards and Technology (NIST) servers. In this example, the update lists 117 may include national vulnerability database that is hosted by the NIST servers. The NIST server may host the information assurance vulnerability alerts (IAVAs), which may be an example of the update lists 117. One with skill in the art may be familiar with other suitable examples of the third-party server 104 and the update lists 117. Lists of vulnerabilities and threats are maintained by some additional entities such as MITRE.

The depicted example of the operating environment 100 includes the support device 113. The support device 113 may be a hardware-based computer device configured to communicate data and information with the other components of the operating environment 100 via the network 120. In examples that include the support device 113, the update lists 117 may be consumed at the support device to generate an update catalog 111. The update catalog 111 includes records and information related to previous product updates. As the update lists 117 become available, update metadata or other information may be appended to the update catalog 111.

The support device 113 may communicate the update catalog 111 to the management device 102 or may otherwise make available the update catalog 111. For instance, the support device 113 may also communicate the update catalog 111 to a separate host that is connected to the network 120. The update catalog 111 may be accessed from the separate host and stored on a suitable storage medium. The management device 102 may then access the update catalog 111 from the storage medium.

The update catalog 111 may be stored at least temporarily at the management device 102. In other instances, the update catalog 111 may be stored remotely and accessed by the management device 102 via the network 120. In FIG. 1, the update catalog 111 is depicted as being communicated outside the network 120. In some examples, the update catalog 111 may be communicated or accessed via the network 120.

In some examples, the operating environment 100 may not include the support device 113. In these examples, the management device 102 might directly consume information of the update lists 117.

The depicted example of the operating environment 100 includes the distribution server 112. The distribution server 112 may be a hardware-based server configured to communicate data and information with the other components of the operating environment 100 via the network 120. The distribution server 112 may be configured to store published product updates or instructions related to published product updates. For example, in some examples, the management device 102 may communicate one or more product updates to the distribution server 112. One or both of the endpoints 106 may then access the product updates at the distribution server 112. After the product updates are accessed, the product updates may be implemented at one or both of the endpoints 106 to modify code of one of the products 115a or 115b on the endpoints 106. An example of the distribution server 112 may include a Windows® Server Update Services (WSUS) server.

In the depicted example, the distribution server 112 is not included in the managed network 110. In some examples, the distribution server 112 may be included in the managed network 110. For instance, in some examples in which the distribution server 112 includes the WSUS server, it may be included in the managed network 110. In some examples, the operating environment 100 may omit the distribution server 112. Additionally or alternatively, the distribution server 112 may be used for a portion of product updates and not used for another portion of the product updates.

The managed network 110 includes the management device 102 and the endpoints 106. The managed network 110 is implemented to enable management of the endpoints 106 by the management device 102. To implement the managed network 110, the endpoints 106 may be enrolled. After the endpoints 106 are enrolled, ongoing management of the endpoints 106 may be implemented by the management device 102. The ongoing management may include overseeing and dictating at least a part of the operations at the endpoints 106 as well as dictate or control product updates implemented at the endpoints 106 as described in the present disclosure.

The management device 102 is configured to manage product updates at the endpoints 106. In general, management of the product updates may include determining which product updates pertain to product(s) 115a and 115b (collectively, products 115), to determine which of the product updates to distribute to the endpoints 106, and to distribute the product updates to the endpoints 106 such that the product updates may be locally implemented.

Implementation of the product updates at the endpoints 106 include modification to computer code, programming code, or computer-executable instructions of a program that comprises the products 115.

The endpoints 106 may include hardware-based computer systems that are configured to communicate with the other components of the operating environment 100 via the network 120. The endpoints 106 may include any computer device that may be managed by the management device 102 and/or have been enrolled in the managed network 110. Generally, the endpoints 106 include devices that are operated by the personnel and systems of an enterprise or store data of the enterprise. The endpoints 106 might include workstations of an enterprise, servers, data storage systems, printers, telephones, internet of things (IoT) devices, smart watches, sensors, automobiles, battery charging devices, scanner devices, etc. The endpoints 106 may also include virtual machines, which may include a portion of a single processing unit or one or more portions of multiple processing units, which may be included in multiple machines. The endpoints 106 may be referred to as endpoints when the endpoints 106 are included in the managed network 110.

The endpoints 106 include the products 115 and an agent 119a or 119b. For instance, in the depicted example, a first endpoint 106a may include first products 115a and a first agent 119a and a second endpoint 106b may include second products 115b and a second agent 119b. The first and second agents 119a and 119b are generally referred to as agent 119 or agents 119 and the first products 115a and the second products 115b are generally referred to as products 115 or products 115.

The agents 119 may be locally installed at least temporarily on the endpoints 106. For instance, the agents 119 may be installed on the endpoints 106 when the endpoints 106 are enrolled in the managed network 110 or when a particular service is loaded at the endpoints 106. The agents 119 may have access to information related to the products 115 and may be configured to communicate the information such as product metadata related to the products 115 to the management device 102. For instance, the first agent 119a may have access to information related to the first products 115a. On its own or responsive to a request (from the management device 102 or another endpoint 106), the first agent 119a may communicate the information related to the first products 115a to the management device 102. The information related to the first products 115a may include a current inventory of the first products 115a as well as information or product metadata related to the first products 115a such as version, vendor, type, hardware integrations, size, privacy policy, software interfaces, and the like. The agents 119 may also implement administrative and/or management processes within the managed network 110.

The products 115 may include applications of any kind or type. Some examples of the products 115 may include software applications, enterprise software, operating systems, and the like. The first products 115a may not be the same as the second products 115b. For instance, the first products 115a may include a first set of software applications while the second products 115b may include a second set of software applications, which may include at least one software application that is not included in the first set of software applications.

The management device 102 may include a hardware-based computer system that is configured to communicate with the other components of the operating environment 100 via the network 120. The management device 102 may be associated with an administrator 108. The administrator 108 may be an individual, a set of individuals, or a system that interfaces with the management device 102. In some examples, the administrator 108 may provide input to the management device 102. The input provided by the administrator 108 may form the basis of some computing processes performed by the management device 102. For example, the administrator 108 may provide user input at a user interface associated with the management device 102.

The management device 102 may include an update management module 116 (in the Figures, “update MGMT module”). The update management module 116 may be configured for automated software management of the endpoints 106 of the managed network 110. The automated software management may be based on discovery of the products 115 and improved management based on the discovered products 115.

For example, in some examples, the update management module 116 may be configured to import update metadata. The update metadata may be consumed from the update lists 117 or may be received as part of an update catalog 111. As described above, the update lists 117 may include cybersecurity vulnerabilities and product updates, which may be related to or pertain to the products 115.

The agent (e.g., first agent 119a) may identify a reboot policy and identify a first update operation. The reboot policy may indicate one or more reboot behaviors initiated after update operations are performed at the endpoint. The first update operation may be associated with a first level of criticality based on metadata. The metadata may be associated with an instruction implemented to locally perform the first update operation on the endpoint. The agent may compare the first level of criticality of the first update operation with the reboot policy to determine a first reboot behavior. The agent may transition the endpoint state to a first reboot state. The first reboot state may actuate the first reboot behavior. The first reboot state may be one or more of an advised reboot state, a mandatory reboot state, or a critical reboot state. The agent may actuate the first reboot behavior using the first reboot state.

The agent 119, the update management module 116, the products 115, and components thereof may be implemented using hardware including a processor, a microprocessor (e.g., to perform or control performance of one or more operations), a field-programmable gate array (FPGA), or an application-specific integrated circuit (ASIC). In some other instances, the agent 119, the update management module 116, the products 115, and components thereof may be implemented using a combination of hardware and software. Implementation in software may include rapid activation and deactivation of one or more transistors or transistor elements such as may be included in hardware of a computing system (e.g., the endpoints 106 or the management device 102 of FIG. 1). Additionally, software defined instructions may operate on information within transistor elements. Implementation of software instructions may at least temporarily reconfigure electronic pathways and transform computing hardware.

The managed network 110 may be associated with an enterprise, a portion of an enterprise, a government entity, or another entity or set of devices (102, 113, 106, or 112). In some examples, the management device 102 may be a single server, a set of servers, a virtual device, or a virtual server in a cloud-base network of servers. In these and other examples, the update management module 116 may be spread over two or more cores, which may be virtualized across multiple physical machines.

Modifications, additions, or omissions may be made to the operating environment 100 without departing from the scope of the present disclosure. For example, the operating environment 100 may include one or more managed networks 110, one or more management devices 102, one or more support devices 113, one or more endpoints 106, one or more third-party servers 104, one or more distribution servers 112, or any combination thereof. Moreover, the separation of various components and devices in the examples described herein is not meant to indicate that the separation occurs in all examples. Moreover, it may be understood with the benefit of this disclosure that the described components and servers may generally be integrated together in a single component or server or separated into multiple components or servers.

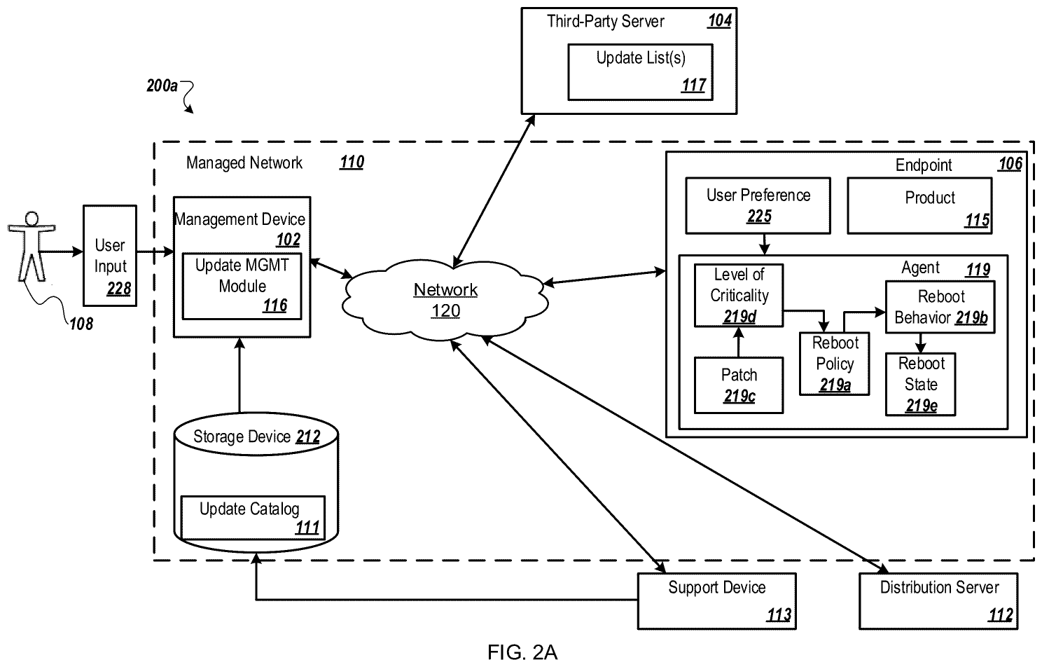

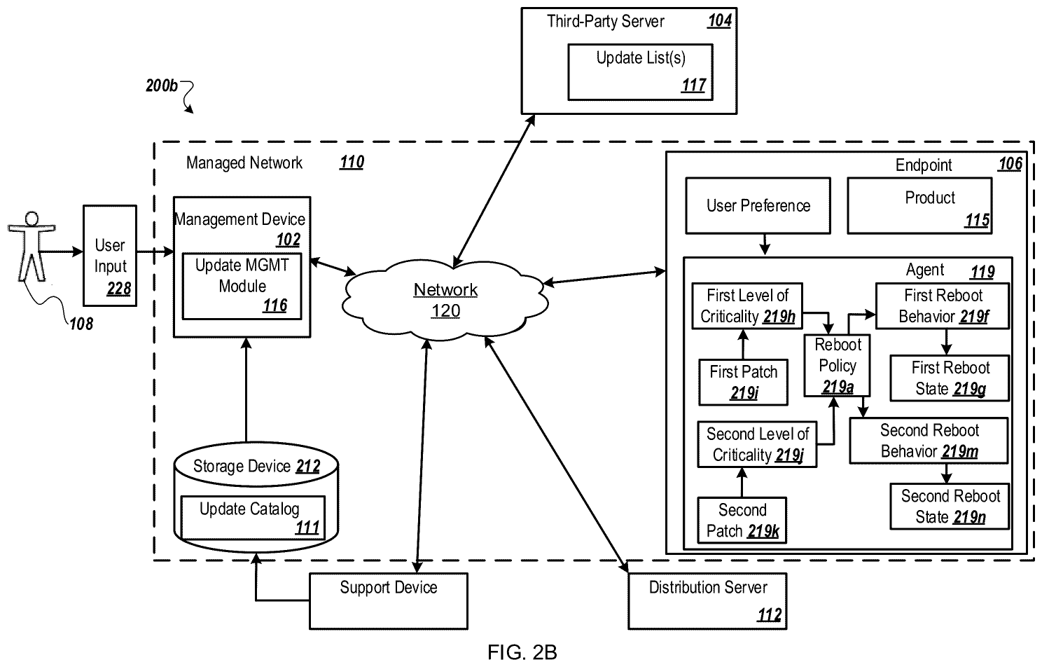

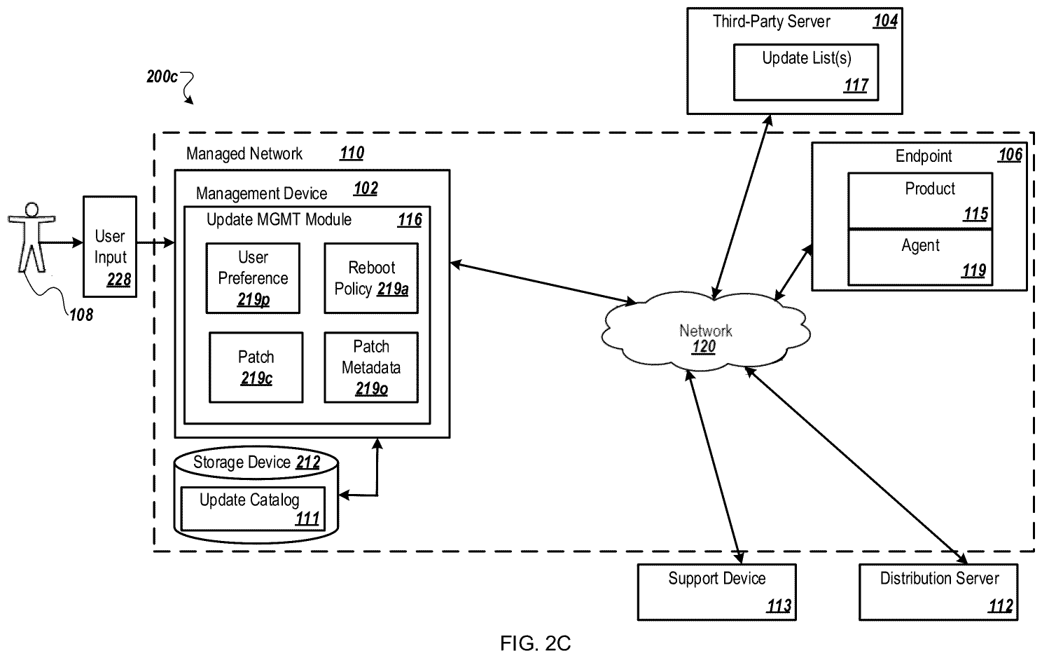

FIG. 2A depicts a block diagram of a first example automated software management process (first management process) 200a that may be implemented in the operating environment 100 of FIG. 1 or another suitable environment. The first management process 200a of FIG. 2A may include one or more components (102, 104, 106, 108, 110, 111, 112, 113, 117, 115, 116, and 119) described with reference to FIG. 1. In some embodiments, the update catalog 111 may be stored on a suitable storage medium (e.g., storage device 212).

The first management process 200a may be effectuated using one or more operations. For instance, the first management process 200a may begin when the agent 119 identifies a reboot policy 219a and a first update operation (e.g., installation of a patch 219c). The reboot policy 219a may indicate one or more reboot behaviors 219b after a software update installation (e.g., a patch installation). The first update operation may be associated with a first level of criticality 219d. The first level of criticality 219d may be based on metadata associated with an instruction implemented to locally perform the first update operation on the endpoint 106. The agent 119 located on the endpoint 106 compares the first level of criticality 219d of the first update operation with the reboot policy 219a to determine a first reboot behavior 219b.

The agent 119 located on the endpoint 106 transitions an endpoint state to a first reboot state 219e to actuate a reboot behavior 219b. The first reboot state 219e may include one or more of an advised reboot state, a mandatory reboot state, or a critical reboot state. The agent 119 may actuate the first reboot behavior 219b using the first reboot state 219c.

The management device 102, e.g., via the update MGMT module 116, communicates the reboot policy 219a to the agent 119. The agent 119 may define the reboot behavior 219b and set the reboot state 219e for the endpoint 106 using the reboot policy 219a. When the management device 102 is determining the reboot policy 219a, e.g., at the update MGMT module 116, the management device 102 may communicate the risks of different reboot policies to the management device 102.

The agent 119 determines whether a reboot request is sent to a graphical user interface of the endpoint 106 based on a reboot policy 219a (e.g., when an agent 119 receives a reboot request). When the agent 119 receives a reboot request and identifies the reboot policy 219a, the agent 119 compares the reboot request to other reboot requests to determine which reboot request has a highest level of criticality. The agent 119 actuates the reboot based on the reboot policy 219a.

Providing the reboot policy 219a to the endpoint 106 allows for the asynchronous communication of the reboot policy 219a compared to the communication of an update (e.g., a patch) to one of the products 115. For example, a patch may be provided to the endpoint 106, a selected period of time after the endpoint 106 has received the reboot policy 219a. In one example, the selected period of time may be selected from a range including less than 30 seconds, less than 5 minutes, less than 1 hour, or any other suitable period of time. In some examples, the reboot policy 219a may be a static policy for a selected period of time. In other examples, the reboot policy 219a may be a dynamic policy that may vary based on software updates.

The reboot policy 219a indicates the reboot behaviors 219b after a software update installation. The reboot behaviors 219b may be based on a level of criticality 219d. The level of criticality 219d may be based on one or more of a criticality score, a patch type, a vulnerability type, other characteristics of the update, or combinations thereof. The criticality score may be a metric used to measure the criticality of the reboot. The patch type may be one or more of: binary patches, source code patches, large patches, or the like. The vulnerability type may be identified using a CVE list.

The reboot policy 219a may associate different levels of criticality with different reboot behaviors. For example, the level of criticality 219d may be associated with an advised reboot behavior. The advised reboot behavior may include deferring a reboot for a first period of time. The first period of time may be selected from a range including less than 30 seconds, less than 5 minutes, less than 1 hour, or any other suitable period of time for delaying an advised reboot that is not a mandatory reboot or a critical reboot. In some examples, the first period of time may be as long as the period of time for another, different reboot to occur. That is, the advised reboot behavior may include deferring the reboot until a different reboot (e.g., a different advised reboot, a mandatory reboot, or a critical reboot) occurs.

The level of criticality 219d may be associated with a mandatory reboot behavior. The mandatory reboot behavior may include deferring the reboot for a second period of time, in which the second period of time is less than the first period of time used for advised reboot behavior. The mandatory reboot behavior may include deferring a reboot for a second period of time in which the second period of time may be selected from a range including one or more of less than 30 seconds, less than 5 minutes, less than 1 hour, or any other suitable period of time for delaying a mandatory reboot that is not a critical reboot. In one example, the second period of time may be less than 1 day.

The level of criticality 219d may be associated with a critical reboot behavior. The critical reboot behavior may include deferring the reboot for a third period of time. The third period of time may be selected from a range including one or more of less than 30 seconds, less than 5 minutes, or any other suitable period of time that is less than the second period of time and less than the first period of time. That is, the first period of time (e.g., for an advised reboot behavior) may be longer than the second period of time (e.g., for a mandatory reboot behavior), and the second period of time (e.g., for the mandatory reboot behavior) may be longer than the third period of time (e.g., for the critical reboot behavior). In one example, the third period of time may be an amount of time adequate to allow a user to close operational applications and save files before the reboot.

The level of criticality 219d may be associated with times that may be changed. For example, for an advised reboot behavior, the reboot policy may allow for a deferred reboot for a period of 96 hours. The time may be reduced and/or lengthened based on a user experience. A user may reduce the period to the end of the day, or the user may lengthen the period of time for a week.

The agent 119 may identify on the endpoint 106, a first update associated with the level of criticality 219d. The first update operation may be received from the management device 102 via the update MGMT module 116 and stored locally at the agent 119. Alternatively or in addition, the first update operation may be generated locally at the agent 119 and stored at the agent 119. The first update operation includes metadata that may include one or more of a criticality score, a patch type, a vulnerability type, the like, or a combination thereof. The first update operation may be associated with the level of criticality 219d which may include one or more of an advised level of criticality, a mandatory level of criticality, a critical level of criticality, or the like. Although three levels of criticality have been illustrated, any suitable number of levels of criticality may be used to distinguish between different reboot behaviors 219b using different reboot states 219c.

The agent 119 compares the level of criticality 219d of the first update operation with the reboot policy 219a to determine a reboot behavior 219b. For example, the reboot policy 219a may determine that an advised level of criticality allows a reboot behavior in which a reboot occurs within 30 days; a mandatory level of criticality allows a reboot behavior in which a reboot occurs by the end of the day; and a critical level of criticality allows a reboot behavior in which a reboot occurs within 10 minutes.

The agent 119 may transition an endpoint state to a reboot state 219e to actuate the reboot behavior 219b. For example, the endpoint state may be in an idle state in which the reboot behavior 219b does not use a reboot. The idle state may transition to an advised state when the level of criticality 219d and the reboot policy 219a determines that an advised reboot behavior is to be enabled. The idle state may transition to a mandatory state when the level of criticality 219d and the reboot policy 219a determines that a mandatory reboot behavior is to be enabled. The idle state may transition to a critical state when the level of criticality 219d and the reboot policy 219a determines that a critical reboot behavior is to be enabled.

In some embodiments, a user preference 225 may be received at the endpoint 106 from the administrator 108 as user input 228 via the management device 102, the update MGMT module 116, and the network 120. The user preference 225 may be used to determine how the reboot policy 219a uses the level of criticality 219d to determine the reboot behavior 219b and the reboot state 219c. Information relating to the level of criticality 219d associated with the first update operation may be provided at the endpoint 106. The agent 119 may receive the user preference 225 for the first level of criticality associated with the first update operation. The agent 119 may adjust the reboot behavior 219b based on the user preference 225.

The different levels of criticality may result in a change in state. FIG. 2B depicts a block diagram of a second example automated software management process (second management process) 200b that may be implemented in the operating environment of FIG. 1 or another suitable environment. The second management process 200b of FIG. 2B may include one or more components (e.g., 102, 104, 106, 108, 110, 111, 112, 113, 117, 115, 116, and 119) described with reference to FIG. 1.

The second management process 200b may include the agent actuating the first reboot behavior 219f. The first reboot behavior 219f may be actuated when the level of criticality 219h for the first update operation is a highest level of criticality as compared to one or more additional levels of criticality (e.g., second level of criticality 219j) for one or more additional update operation (e.g., installation of a second patch 219k) identified by the agent 119. The agent 119 may also pause the first reboot behavior 219f. For instance, the agent 119 may pause the first reboot behavior 219f when the first level of criticality 219h for the first patch 219i is not a highest level of criticality when compared to the second level of criticality 219j for the second patch 219k.

A level of criticality is a highest level of criticality compared to one or more additional levels of criticality when the level of criticality is higher than each of the one or more additional levels of criticality. For example, a critical level of criticality is the highest level of criticality when compared to the mandatory level and the advised level. The mandatory level may be the highest level of criticality when compared to the advised level of criticality. In another example, the advised level is the highest level when not compared to a critical level or a mandatory level.

A level of criticality may be equal to another level of criticality when the level of criticality is the same. For example, the level of criticality for an advised level of criticality for a patch may be equal to other advised levels of criticality for one or more additional patches. In another example, the level of criticality for a mandatory level of criticality for a patch may be equal to other mandatory levels of criticality for one or more additional patches. In another example, the level of criticality for a critical level of criticality for a patch may be equal to other critical levels of criticality for one or more additional patches.

The agent 119 may receive via the network 120 from the management device 102 having the update MGMT module 116, a second patch 219k associated with a second level of criticality 219j. The second level of criticality 219j may be based on metadata of the second patch 219k. The second patch 219k may be stored at the agent 119. Alternatively or in addition, the second patch 219k may be generated locally at the agent 119 on the endpoint 106 and stored at the agent 119.

The second patch 219k may allow for an update in the endpoint state. The second management process 200b may include identifying, at the agent 119 on the endpoint 106, a second patch 219k associated with a second level of criticality 219j. The second level of criticality 219j may be based on metadata of the second patch 219k. The agent 119 may compare, on the endpoint 106, the second level of criticality 219j of the second update operation with the reboot policy 219a to determine a second reboot behavior 219m. The agent may compare, on the endpoint 106, the second level of criticality 219j and the first level of criticality 219h. The agent may update the endpoint state to: (i) the first reboot state 219g when the second level of criticality 219j is not higher than the first level of criticality 219h, or a second reboot state 219n when the first level of criticality 219h is not higher than the second level of criticality 219j. In one example, when the first level of criticality 219h is equal to the second level of criticality 219j, the agent may update the endpoint state to the first reboot state 219g. For example, when the first level of criticality is a mandatory level of criticality and the second level of criticality is a mandatory level of criticality, the reboot state may be a mandatory reboot state.

When the endpoint state is updated to the second reboot state 219n, the second reboot state 219n may be based on the second reboot behavior 219m. For example, when the endpoint state is updated to the second reboot state 219n, which may be a critical reboot state, the second reboot behavior 219m may include reboot behavior associated with the critical reboot behavior. That is, the reboot behavior may include rebooting the endpoint 106 after a selected period of time has elapsed to allow a user to close programs, save files, or the like.

FIG. 2C is a block diagram of a third automated software management process 200c that may be implemented in the operating environment 100 of FIG. 1 or another suitable environment. The third management process 200b of FIG. 2B may include one or more components (e.g., 102, 104, 106, 119) described with reference to FIG. 1.

The management device 102 may be operable to generate and send a reboot policy to the agent 119. For instance, the update MGMT module 116 may generate the reboot policy which is then communicated to the agent 119. The reboot policy indicates one or more reboot behaviors initiated after update operations are performed. The management device 102 sends a first update operation (e.g., installation of the patch 219c) associated with a level of criticality. The level of criticality is based at least partially on metadata 2190 of the first update operation. The level of criticality may include an advised level associated with an advised state actuating an advised reboot behavior, a mandatory level associated with a mandatory state actuating a mandatory reboot behavior, or a critical level associated with a critical state actuating a critical reboot behavior. The first level of criticality may be based on one or more of a criticality score, a patch type, a vulnerability type, the like, or a combination thereof.

In addition, the management device 102 may be operable to perform one or more of: associating the first level of criticality with an advised reboot behavior in which the advised reboot behavior includes deferring a reboot for a first period of time; associating the first level of criticality with a mandatory reboot behavior in which the mandatory reboot behavior includes deferring the reboot for a second period of time; and associating the first level of criticality with a critical reboot behavior in which the critical reboot behavior includes deferring the reboot for a third period of time. The first period of time may be longer than the second period of time, and the second period of time may be longer than the third period of time.

The management device 102 may receive user input 228 from the administrator 108. The user input 228 may include the user preference 219p. The user preference 219p may provide information related to the first level of criticality associated with update operations. The user preference 219p may be received in response to information provided to the administrator 108 at the management device 102. The information provided to the administrator 108 may include information related to the first level of criticality associated with the patch 219c. The information associated with the first level of criticality associated with the patch 219c may be information about one or more of a criticality score, a patch type, a vulnerability type, the like, or a combination thereof. Alternatively or in addition, the information associated with the first level of criticality associated with the patch 219c may be information about an effect of a reboot policy 219a on the first level of criticality associated with the patch 219c. For example, the information may include the reboot behavior that is associated with the first level of criticality based on the reboot policy 219a.

The user preference 219p may be sent, via the network 120, from the management device 102 to the agent 119. The user preference 219p may be for the level of criticality associated with the patch 219c. At the agent 119, reboot behavior may be adjusted based on the user preference 219p. For example, default reboot behavior may be adjusted to a reboot behavior defined by the user preference 219p. For instance, when one or more of an advised reboot behavior, a mandatory reboot behavior, or a critical reboot behavior is to be actuated by the agent 119, the user preference 219p may adjust the period of time before a reboot occurs.

The agent 119 receives data from the management device 102. For instance, the agent 119 may receive a first update operation from the management device 102 via the network 120. The agent 119 also receives metadata associated with the first update operation from the management device 102. In some embodiments, the metadata and the first update operation are included in an update package. The update package might include instructions, metadata, the update operation (e.g., patch 219c), a link (e.g., a uniform resource locator (URL)) to the patch 219c), or some combination thereof. The first update package may include instructions implemented to initiate the first update operation and the metadata of the first update operation.

The agent 119 may receive the reboot policy 219a from the management device 102. The reboot policy 219a is defined by the management device 102 and includes definitions update operation criteria that associate the first update operation with one or more of the advised reboot state, the mandatory reboot state, or the critical reboot state.

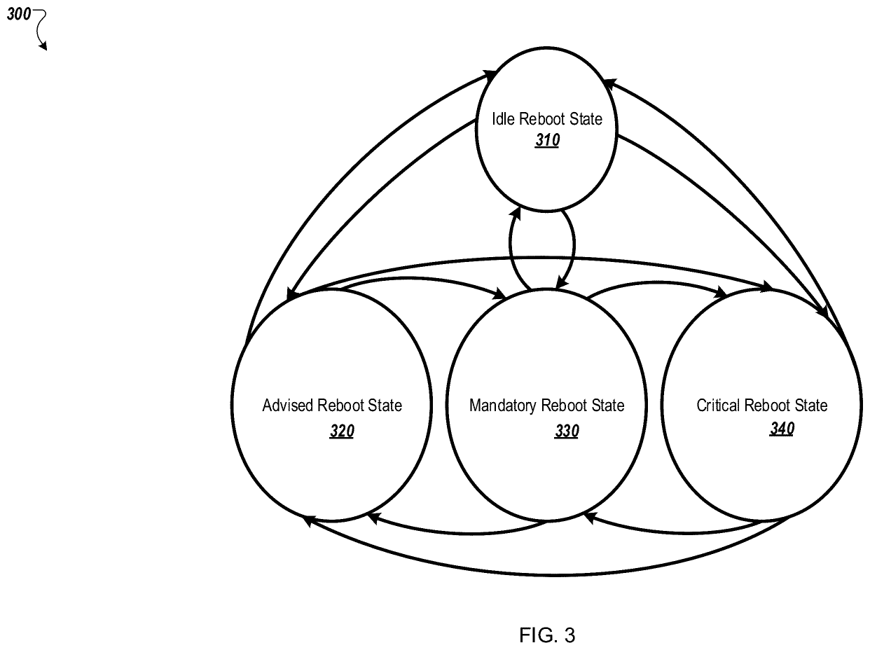

FIG. 3 is an example state diagram 300 that may be implemented in the processes 200a-200c of FIGS. 2A-2C. The state diagram 300 is implemented in an endpoint such as the endpoint 106 of FIGS. 1-2C and illustrates transitions between different states. The transitions between states may be based on the level of criticality (e.g., 219d), the reboot policy (e.g., 219a), the reboot behavior (e.g., 219b), or combinations thereof.

In some embodiments, the level of criticality includes an advised level, a mandatory level, and a critical level. The advised level is associated with the advised state which actuates an advised reboot behavior. For the advised level, the endpoint may be enhanced after the reboot occurs. The mandatory level is associated the mandatory state that actuates a mandatory reboot behavior. For the mandatory level, the endpoint may be enhanced, or the update may be completed after the reboot occurs, the endpoint may be inoperable without the patch, and the reboot is needed after the patch installation. The critical level is associated with the critical state that actuates a critical reboot behavior. For the critical level, the endpoint is not secure or stable without the reboot.

Referring to FIG. 3, the first reboot state may be an advised reboot state 320. The advised reboot state 320 may facilitate advised reboot behavior. The second reboot state may be a mandatory reboot state 330. The mandatory reboot state 330 may facilitate mandatory reboot behavior. The third reboot state may be a critical reboot state 340. The critical reboot state 340 may facilitate critical reboot behavior. The idle reboot state 310 may be a reboot state in which no reboot is planned. That is, the reboot behavior associated with the idle reboot state 310 may be no reboot.

The endpoint transitions between reboot states (310, 320, 330, or 340) responsive to reboot behaviors determined by the endpoint or an agent (e.g., 119). The endpoint can transition from any of the reboot states to any other of the reboot states. For instance, when the endpoint is in the idle reboot state 310, the endpoint may transition to another of the reboot states (320, 330, or 340). For instance, when a reboot behavior (e.g., reboot behavior 219b of FIG. 2A) is an advised reboot behavior, the endpoint transitions from the idle reboot state 310 to the advised reboot state 320. Similarly, when the reboot behavior is a mandatory reboot behavior, the endpoint transitions from the idle reboot state 310 to the mandatory reboot state 330. When the reboot behavior is a critical reboot behavior, the endpoint transitions from the idle reboot state 310 to the critical reboot state 340.

The endpoint may also transition from the advised reboot state 320 to another of the reboot states (310, 320, or 330). For instance, when the endpoint is in the advised reboot state 320, the endpoint 106 may transition to the idle reboot state 310 responsive to the reboot behavior being an idle reboot behavior. This may occur when a patch installation associated with an advised reboot state 320 is canceled. Additionally, when the reboot behavior is a mandatory reboot behavior, the endpoint 106 may transition from the advised reboot state 320 to the mandatory reboot state 330 and when the reboot behavior is a critical reboot behavior, the endpoint 106 may transition from the advised reboot state 320 to the critical reboot state 340. Similarly, the endpoint can transition from the mandatory reboot state 330 to another of the reboot states 310, 320, or 340 based on the reboot behavior or from the critical reboot state 340 to another of the reboot states 310, 320, or 330 based on the reboot behavior. Transitions from the mandatory reboot state 330 to the idle or advised reboot states 310 or 320 may occur when a patch installation associated with a mandatory reboot state 330 is canceled. When another patch installation is not pending, the endpoint transitions to the idle reboot state 310. When a patch installation associated with an advised reboot state 320 remains, the endpoint transitions to the advised reboot state 320.

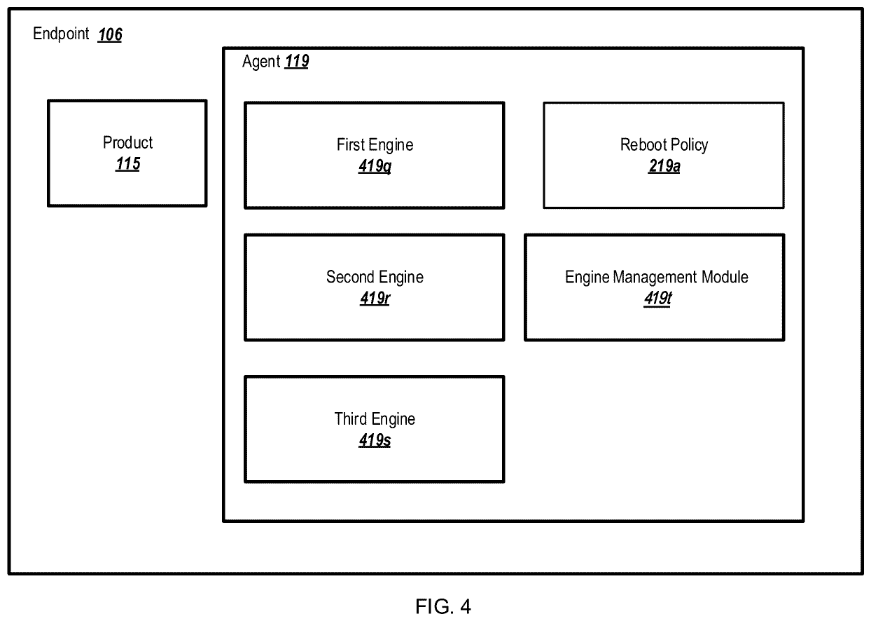

FIG. 4 is a block diagram of an example of the endpoint 106 that may be implemented in the operating environment 100 of FIG. 1 and the processes 200a-200c of FIGS. 2A-2C. The endpoint 106 includes the agent 119 having engines 419q, 419r, and 419s (generally, engines 419q-419s) and an engine management module 419t.

The engines 419q-419s control management of different aspects of the endpoint 106. For example, a first engine 419g may be a patch engine that controls installation of patches at the endpoint 106, a second engine 419r may be an application engine that controls the software applications loaded to the endpoint 106. A third engine 419s may be a service management engine that controls the communication of support tickets and implementation of corrective issues at the endpoint 106. The engines 419q-419s may operate independently of one another.

A cloud server such as the management device 102 may interface with the agent 119 to communicate one or more control messages to the agent 119. The control messages may be interpreted by the engines 419q-419s. Additionally, the cloud server may communicate policies used to control operations at the endpoint 106. The policies include static portions that are communicated to the endpoint 106 and locally enforced by the agent 119. The policies include a reboot policy such as the reboot policy 219a. The reboot policy or portions thereof may be associated with one or more of the engines 419q-419s. For instance, the reboot policy might include a specific policy instruction directed to the first engine 419q that determines reboot behaviors for update operations associated with the first engine 419q. Accordingly, each of the engines 419q-419s may implement a specific reboot behavior.

The engines 419q-419s may be operable to transition the endpoint 106 between different states based on the reboot policy and level of criticality. For instance, the engines 419q-419s may determine when a reboot occurs based on the level of criticality that is based on the metadata of the update packages.

The engine management module 419t is configured to harmonize and prioritize reboot behaviors of update operations implemented by the engines 419q-419s. For instance, a first update operation (e.g., installation of the first patch 219i) may be performed by the first engine 419q. The first engine 419q may perform the first update operation based on the first update package. The first update package may include instructions implemented to initiate the first update operation and metadata of the first update operation. The engine management module 419t identifies the first level of criticality of the first update operation. An additional update operation (e.g., installation of the second patch 219k) may be performed the second engine 419r. The second engine 419r may perform the additional update operation based on a second update package. The second update package may include instructions implemented to initiate the second update operation and metadata of the second update operation. The engine management module 419t identifies the second level of criticality of the second update operation.

The engine management module 419t prioritizes a highest level of criticality and implements the state transition according to the highest level of criticality of multiple update operations. For instance, the first update operation may include a mandatory behavior, and the second update operation may include a critical behavior. Accordingly, the engine management module 419t prioritizes reboot operations associated with the first update operation.

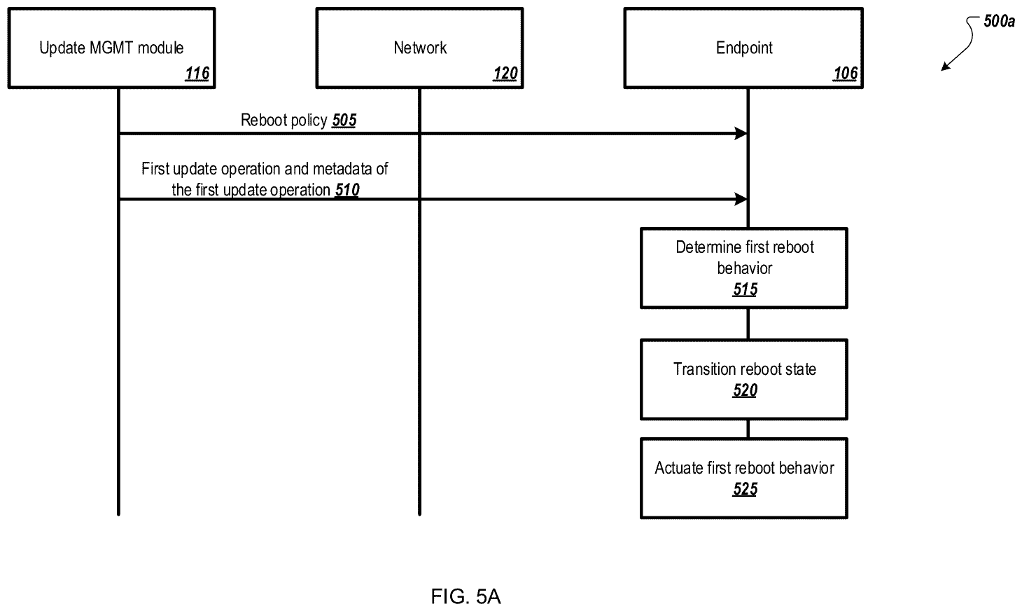

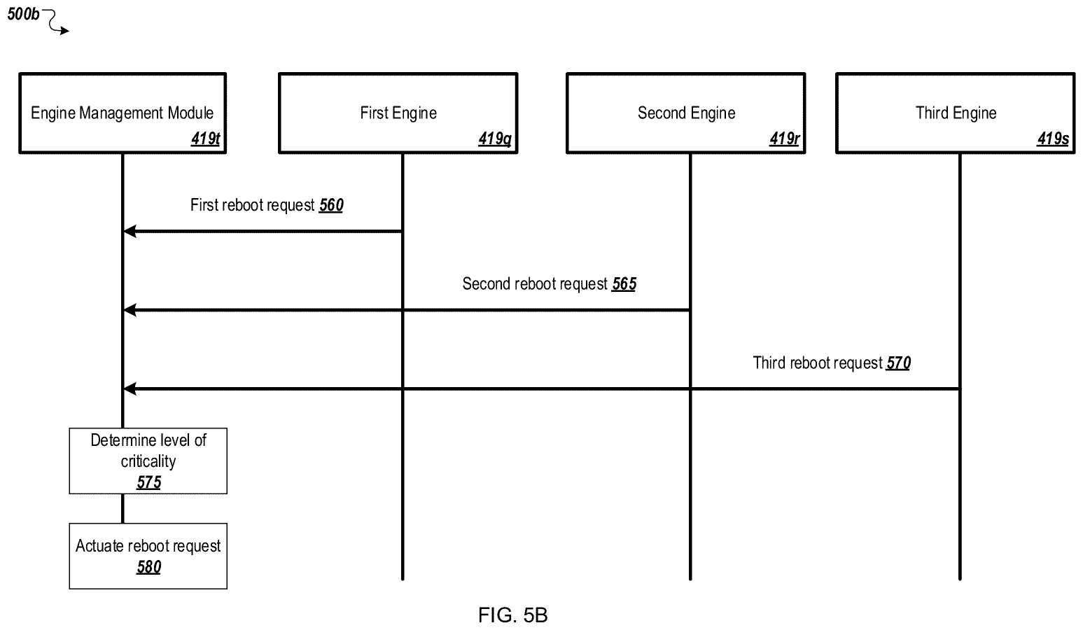

FIG. 5A is a first timing diagram 500a of an example policy communication operation. The first timing diagram 500a includes the update MGMT module 116, the network 120, and the endpoint 106 described elsewhere in the present disclosure. The update MGMT module 116 sends a reboot policy (e.g., 219a of FIG. 4) to the endpoint 106 via the network 120, as shown in operation 505. After the reboot policy is sent to the endpoint 106, the update MGMT module 116 sends the first update operation and metadata of the first update operation to the endpoint 106 via the network 120, as shown in operation 510. The endpoint 106 determines a first reboot behavior, as shown in operation 515. The endpoint 106 transitions the reboot state, as shown in operation 520 and actuates the first reboot behavior, as shown in operation 525.

FIG. 5B is a second timing diagram 500b of reboot prioritization. The second timing diagram 500b includes the engine management module 419t, the first engine 419q, the second engine 419r, and the third engine 419s described with reference to FIG. 4. The first engine 419q sends a first reboot request 560 to the engine management module 419t, as shown in operation 560. The second engine 419r sends a second reboot request 565 to the engine management module 419t, as shown in operation 565. The third engine 419s sends a third reboot request 570 to the engine management module 419t, as shown in operation 570. The engine management module 419t determines the level of criticality, as shown in operation 575. The agent 119 actuates the reboot request, as shown in operation 580, by communicating a state change message to an operating system.

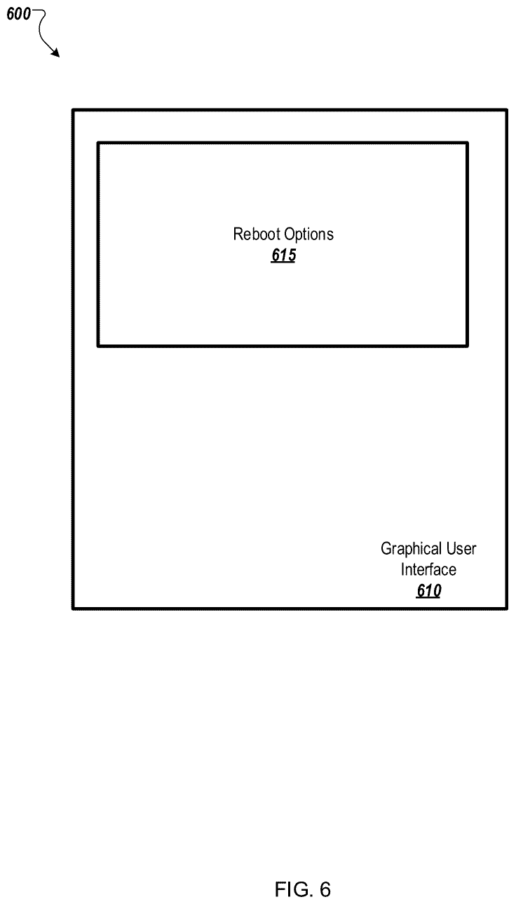

FIG. 6 is a block diagram of a display 600 having information about one or more reboot options 615. The reboot options 615 of the display 600 are associated with a first update operation and are caused to be displayed via a graphical user interface (GUI) 610. For instance, an agent (e.g., 119) may cause display of the GUI 610 as part of actuation of a first reboot behavior (e.g., 525 of FIG. 5A). The information about the reboot options 615 may be based on the first level of criticality.

In some embodiments, the GUI 610 is configured to receive input from a user regarding the reboot options 615. Based on the input from the GUI 610, a reboot may be deferred, scheduled, or immediately initiated. For instance, the reboot actuation may be deferred when the reboot behavior is associated with an advised reboot state. As a first example, the reboot may be deferred until an additional reboot associated with a different patch installation is initiated. A deferred period may be 96 hours or another suitable time period.

As a second example, the reboot may be deferred for a first period of time. For instance, the reboot may be deferred for the selected period of time when the reboot behavior is associated with a mandatory reboot state. The first period of time may be until the end of a day. As a third example, the reboot may be initiated within a selected period of time after the information about one or more reboot options 615 is displayed. The selected period of time may be an amount of time adequate to allow a user to save one or more files and close one or more programs. The reboot may be initiated within the selected period of time when the reboot behavior is associated with a critical reboot state. The amount of time to close one or more applications and save one or more files may be about 10 minutes.

As a fourth example, the reboot may be changed from one time to another time. The GUI 610 may display that the reboot is scheduled for one or more specific times. Input from the GUI 610 may be used to adjust the time of the reboot. For example, the GUI 610 may display reboot times of 4:00 PM, 7:00 PM, 10:00 PM, or 12:00 AM. The user input may select 12:00 AM. The reboot time may be changed to 12:00 AM.

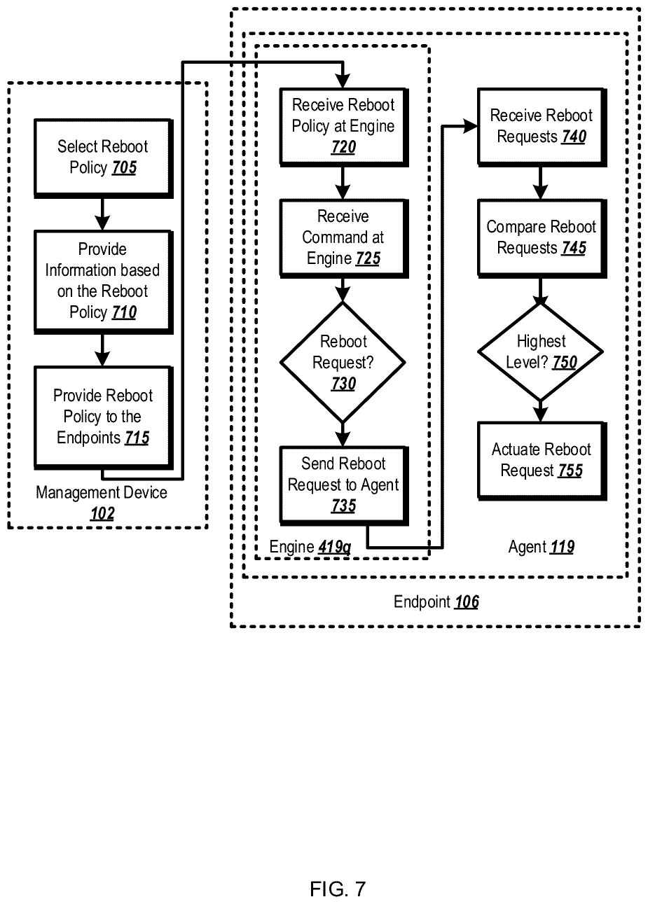

As illustrated in the process flow 700 in FIG. 7, a user (e.g., an admin) may select a reboot policy at a management device 102, as shown in operation 705. The reboot policy may outline levels of criticality and actions to take based on the level of criticality. The level of criticality may relate to a patch. The patch may have a level of criticality such as a common vulnerability scoring system (CVSS) score, which may be measured on a scale from 1 to 10. The level of criticality may be based on metadata of the package being installed or the application being installed. The reboot policy may be associated with different levels of criticality. For instance, for critical updates a first reboot behavior may be implemented, for less critical updates a second reboot behavior may be implemented, and the like.

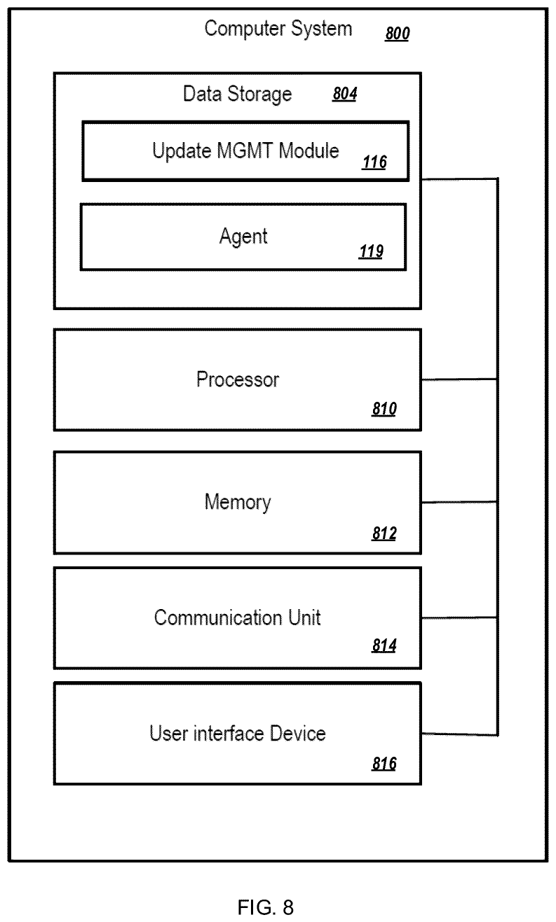

The management device 102 may provide information to a user interface (e.g., a graphical user interface or user interface device 816 of FIG. 8) to provide risks associated with different reboot policies, as shown in operation 710. For example, a reboot policy that assigns all patches as advised may have security and/or operability risks for an endpoint 106. In another example, a reboot policy that assigns all patches as critical may interfere with a user experience because an endpoint may be rebooted at a high frequency.

The management device 102 may provide the reboot policy to the endpoints 715, as shown in operation 715. The endpoint 106 may receive the reboot policy at an engine, as shown in operation 720. The engine may have a portion of the reboot policy and may transition the state of the endpoint based on the portion of the reboot policy.

The engine may receive a command from the management device 102, the endpoint 106, the agent 119, or a combination thereof, as shown in operation 725. During implementation of the command, the engine may determine a reboot request, as shown in operation 730. That is, the reboot operation may have a criticality associated with it based on the information in the command and the processing of the command. The command may include a patch and may include metadata associated with the patch. The metadata associated with the patch may include a level of criticality, which may be used in processing the command. The engine may determine whether a reboot request is to be actuated based on the reboot policy.

The reboot request may be sent to the agent 119, as shown in operation 735. The agent 119 may be operable to control a user interface based on the reboot policy. The agent may determine an action to take in relation to the user interface based on the reboot policy. For example, the agent may send information about patches having a mandatory level of criticality or a critical level of criticality to a user interface, while omitting information about patches having an advised level of criticality.

The agent 119 may receive the reboot request from the engine 419q, as shown in operation 740. The agent may compare reboot requests, as shown in operation 745. That is, the agent may use a reboot policy to determine an action to perform based on one or more reboot requests received at the agent 119 from one or more engines. The agent may effectuate a state 1 to state 2 transformation. That is, the agent may transition the endpoint state from a first reboot state to a second reboot state. The agent 119 may identify one or more reboot requests received at the agent from the one or more engines and determine a highest level of criticality for a reboot request, as shown in operation 750. The agent 119 may actuate the reboot request having the highest level of criticality based on the policy, as shown in operation 755. A conflict between different reboot requests may be processed by defaulting to a reboot request having a highest level of criticality. In one example, when there is not another queued reboot request with a higher level of criticality, then the reboot request may be determined to have a highest level of criticality. In one example, functionality may be independent of one another. That is, an agent 119 with multiple engines implementing one reboot policy may prioritize and manage one or more reboots.

FIG. 8 illustrates an example computer system 800 configured for automated software management of an endpoint, according to at least one example of the present disclosure. The computer system 800 may be implemented in the operating environment 100 FIG. 1, for instance. Examples of the computer system 800 may include the management device 102, one or more of the endpoints 106, the third-party server 104, the support device 113, the distribution server 112, or some combination thereof. The computer system 800 may include one or more processors 810, a memory 812, a communication unit 814, a user interface device 816, and a data storage 804 that includes the update management module 116 and the agent 119 (collectively, modules 116/119).

The processor 810 may include any suitable special-purpose or general-purpose computer, computing entity, or processing device including various computer hardware or software modules and may be configured to execute instructions stored on any applicable computer-readable storage media. For example, the processor 810 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 8, the processor 810 may more generally include any number of processors configured to perform individually or collectively any number of operations described in the present disclosure. Additionally, one or more of the processors 810 may be present on one or more different electronic devices or computing systems. In some examples, the processor 810 may interpret and/or execute program instructions and/or process data stored in the memory 812, the data storage 804, or the memory 812 and the data storage 804. In some examples, the processor 810 may fetch program instructions from the data storage 804 and load the program instructions in the memory 812. After the program instructions are loaded into the memory 812, the processor 810 may execute the program instructions.

The memory 812 and the data storage 804 may include computer-readable storage media for carrying or having computer-executable instructions or data structures stored thereon. Such computer-readable storage media may include any available media that may be accessed by a general-purpose or special-purpose computer, such as the processor 810. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 810 to perform a certain operation or group of operations.

The communication unit 814 may include one or more pieces of hardware configured to receive and send communications. In some examples, the communication unit 814 may include one or more of an antenna, a wired port, and modulation/demodulation hardware, among other communication hardware devices. In particular, the communication unit 814 may be configured to receive a communication from outside the computer system 800 and to present the communication to the processor 810 or to send a communication from the processor 810 to another device or network (e.g., the network 120 of FIG. 1).

The user interface device 816 may include one or more pieces of hardware configured to receive input from and/or provide output to a user. In some examples, the user interface device 816 may include one or more of a speaker, a microphone, a display, a keyboard, a touch screen, or a holographic projection, among other hardware devices.

The modules 116/119 may include program instructions stored in the data storage 804. The processor 810 may be configured to load the modules 116/119 into the memory 812 and execute the modules 116/119. Alternatively, the processor 810 may execute the modules 116/119 line-by-line from the data storage 804 without loading them into the memory 812. When executing the modules 116/119, the processor 810 may be configured to perform one or more processes or operations described elsewhere in this disclosure.

Modifications, additions, or omissions may be made to the computer system 800 without departing from the scope of the present disclosure. For example, in some examples, the computer system 800 may not include the user interface device 816. In some examples, the different components of the computer system 800 may be physically separate and may be communicatively coupled via any suitable mechanism. For example, the data storage 804 may be part of a storage device that is separate from a device, which includes the processor 810, the memory 812, and the communication unit 814, that is communicatively coupled to the storage device. The examples described herein may include the use of a special-purpose or general-purpose computer including various computer hardware or software modules, as discussed in greater detail below.

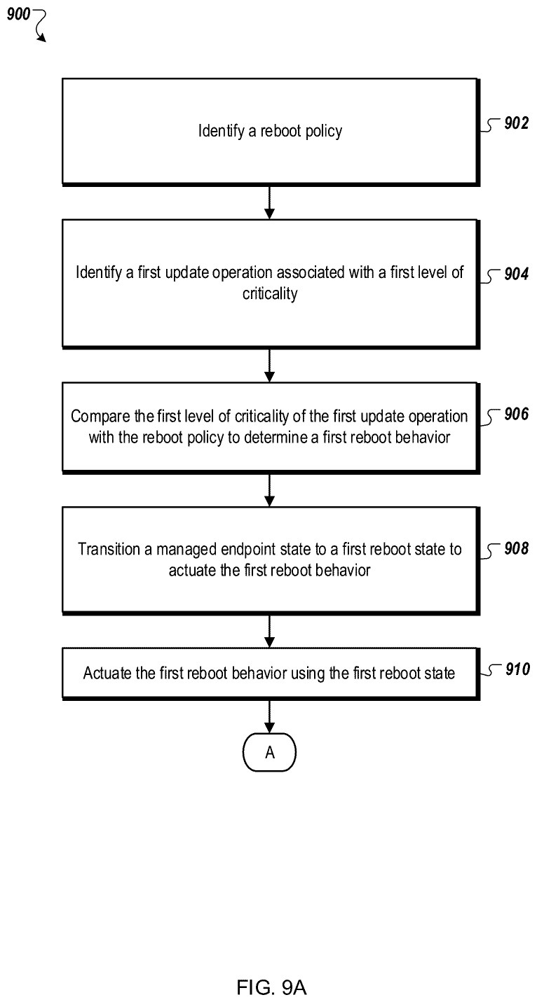

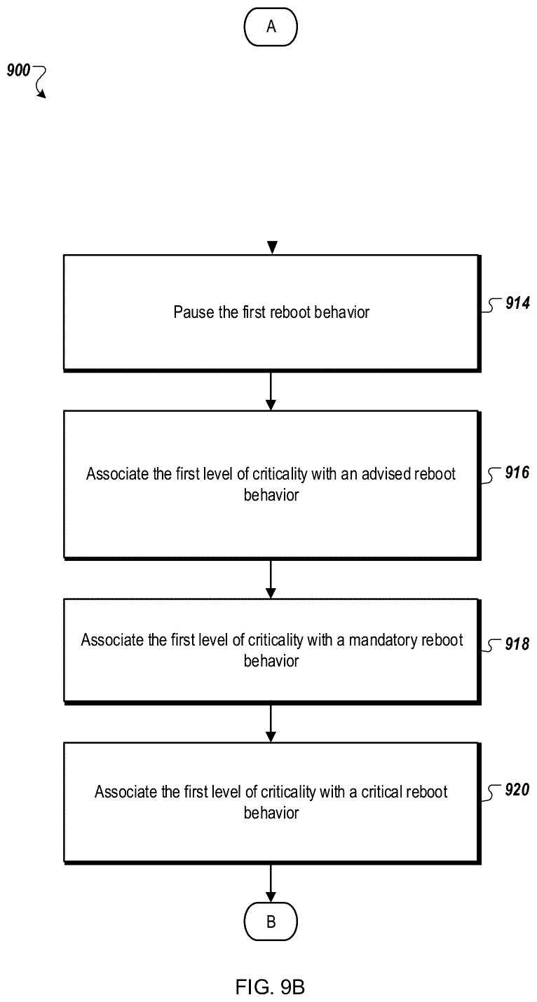

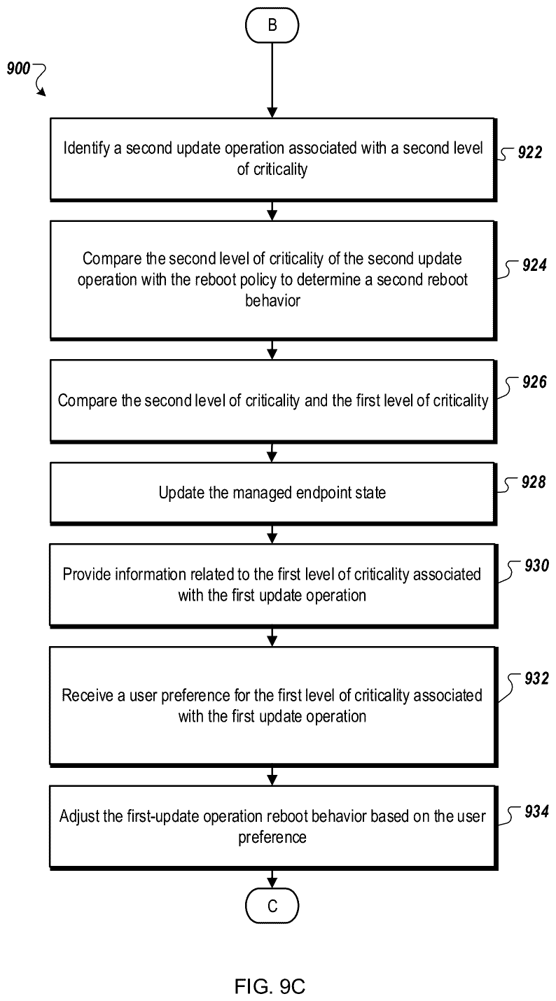

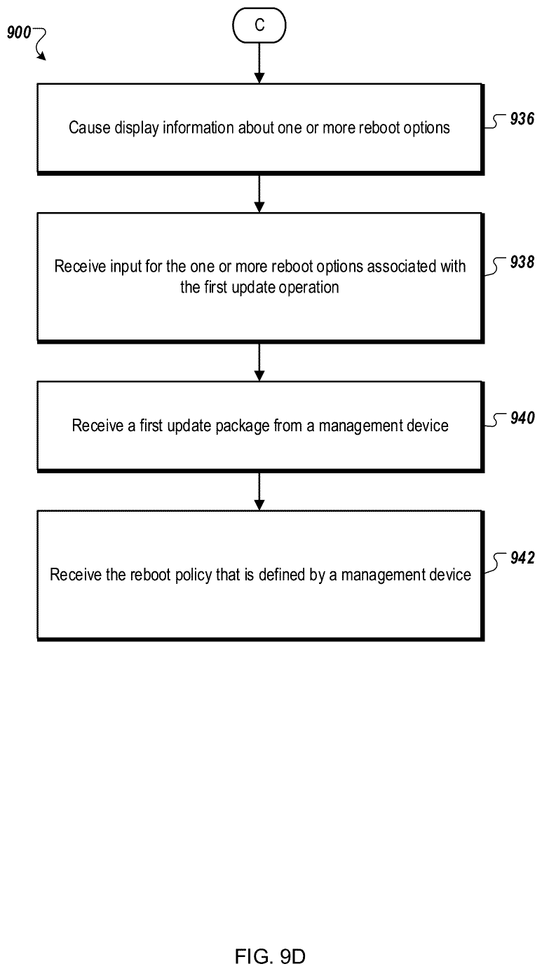

FIGS. 9A-9D are a flow chart of an example method 900 of automated software management, according to at least one example of the present disclosure. As described elsewhere in the present disclosure, the method 900 may involve or may be based on metadata of patches at endpoints. The method 900 may be performed in a suitable operating environment such as the operating environment 100 or the managed network 110 of FIG. 1. The method 900 may be performed by the management device 102 described elsewhere in the present disclosure or by another suitable computing system, such as the computer system 800 of FIG. 8. In some examples, the management device 102 or the other computing system may include or may be communicatively coupled to a non-transitory computer-readable medium (e.g., the memory 812 of FIG. 8) having stored thereon programming code or instructions that are executable by one or more processors (such as the processor 810 of FIG. 8) to cause a computing system or the management device 102 to perform or control performance of the method 900. Additionally or alternatively, the management device 102 may include the processor 810 that is configured to execute computer instructions to cause the management device 102 or another computing system to perform or control performance of the method 900. The management device 102 or the computer system 800 implementing the method 900 may be included in a cloud-based managed network, an on-premises system, or another suitable network computing environment. Although illustrated as discrete blocks, one or more blocks in FIGS. 9A-9D may be divided into additional blocks, combined into fewer blocks, or eliminated, depending on the desired implementation.

Referring to FIG. 9A, the method 900 may begin at block 902 in which the reboot policy may be identified. The reboot policy may be identified at an agent 119 located on the endpoint 106. The reboot policy may indicate one or more reboot behaviors initiated after update operations are performed at the endpoint.

At block 904, a first update operation associated with a first level of criticality may be identified. The first update operation may be identified at an agent 119 located on the endpoint 106. The first level of criticality may be based on metadata of the first update operation. At block 906, the first level of criticality of the first update operation may be compared with the reboot policy to determine a first reboot behavior. The first level of criticality of the first update operation may be compared to the reboot policy at an agent 119 located on the endpoint 106.

At block 908, an endpoint state may be transitioned to a first reboot state to actuate the first reboot behavior. The endpoint state may be transitioned at an agent 119 located on the endpoint 106. The first reboot state may include one or more of an advised reboot state, a mandatory reboot state, or a critical reboot state. At block 910, the first reboot behavior may be actuated using the first reboot state. The first reboot behavior may be actuated at the agent 119 located on the endpoint 106.

Referring to FIG. 9B, at block 912, the method may include block 912 in which the first reboot behavior may be actuated. The first reboot behavior may be actuated at the agent 119 located on the endpoint 106. The first reboot behavior may be actuated when the first level of criticality for the first update operation is a highest level of criticality when compared to one or more additional levels of criticality for one or more additional update operations identified by the agent on the endpoint.

At block 914, the first reboot behavior may be paused. The first reboot behavior may be paused at the agent 119 located on the endpoint 106. The first reboot behavior may be paused when the first level of criticality for the first update operation is not a highest level of criticality when compared to the one or more additional levels of criticality for the one or more additional update operations.

At block 916, the method may include associating the first level of criticality with an advised reboot behavior. The advised reboot behavior may include deferring a reboot for a first period of time. At block 918, the first level of criticality may be associated with a mandatory reboot behavior. The mandatory reboot behavior may include deferring the reboot for a second period of time.

At block 920, the first level of criticality may be associated with a critical reboot behavior. The critical reboot behavior may include deferring the reboot for a third period of time. The first period of time may be longer than the second period of time. The second period of time may be longer than the third period of time.

Referring to FIG. 9C, at block 922, a second update operation may be identified. The second update operation may be identified at the agent 119 on the endpoint 106. The second update operation may be associated with a second level of criticality. The second level of criticality may be based on metadata of the second update operation.

At block 924, the second level of criticality of the second update operation may be compared with the reboot policy to determine a second reboot behavior. The second level of criticality of the second update operation may be compared at the agent 119 on the endpoint 106. At block 926, the second level of criticality and the first level of criticality may be compared. The second level of criticality and the first level of criticality may be compared at the agent 119 on the endpoint 106.

At block 928, the endpoint state may be updated. The endpoint state may be updated at the agent 119 on the endpoint 106. The endpoint state may be updated to the first reboot state when the second level of criticality is not higher than the first level of criticality or when the second level of criticality is equal to the first level of criticality. The endpoint state may be updated to a second reboot state when the first level of criticality is not higher than the second level of criticality. At block 930, information relating to the first level of criticality associated with the first update operation may be provided. The information relating to the first level of criticality associated with the first update operation may be provided at the endpoint 106.

At block 932, a user preference for the first level of criticality associated with the first update operation may be received. The user preference may be received at the agent 119 on the endpoint 106. At block 934, the first reboot behavior may be adjusted based on the user preference. The first reboot behavior may be adjusted at the agent 119 on the endpoint.

Referring to FIG. 9D, at block 936, information about one or more reboot options may cause to be displayed. The one or more reboot options may cause to be displayed via a graphical user interface. The one or more reboot options may be associated with the first update operation. The information about the one or more reboot options may be based on the first level of criticality.

At block 938, input for the one or more reboot options associated with the first update operation may be received. The input may be received via a graphical user interface. At block 940, a first update package may be received from the management device. The first update package may include instructions implemented to initiate the first update operation and the metadata of the first update operation. The first update packaged may be received at the agent 119 on the endpoint 106.

At block 942, the reboot policy may be received. The reboot policy may be received at the agent 119 on the endpoint 106. The reboot policy may be defined by the management device. The reboot policy may include definitions update criteria that associate the first update operation with the advised reboot state, the mandatory reboot state, or the critical reboot state.

In some examples, the method 900 may be performed in managed networks that include multiple endpoints. In examples having managed networks that include multiple endpoints. In these and other examples the method 900 may proceed through one or more of blocks 902, 904, 906, 908, 910, 912, 914, 916, 918, 920, 922, 924, 926, 928, 930, 932, 934, 936, 938, 940, 942, or combinations thereof.

Further, modifications, additions, or omissions may be made to the method 900 without departing from the scope of the present disclosure. For example, the operations of method 900 may be implemented in differing order. Furthermore, the outlined operations and actions are only provided as examples, and some of the operations and actions may be optional, combined into fewer operations and actions, or expanded into additional operations and actions without detracting from the disclosed examples.

The examples described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by hardware (e.g., computer-readable media, processing devices, etc.) of the computing system. In some examples, the different components, modules, engines, and services described herein may be implemented as objects or processes that execute on the computing system (e.g., as separate threads). While some of the system and methods described herein are generally described as being implemented in software (stored on and/or executed by hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe examples of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although examples of the present inventions have been described in detail, it should be understood that the various changes, substitutions, and alterations could be made hereto without departing from the scope of the invention.

What is claimed:

1. A method of automated software management of a managed endpoint, the method comprising:
identifying, at an agent located on the managed endpoint, a reboot policy, wherein the reboot policy indicates one or more reboot behaviors initiated after update operations are performed at the managed endpoint;
identifying, at the agent, a first update operation associated with a first level of criticality based on metadata associated with an instruction implemented to locally perform the first update operation on the managed endpoint;
comparing, at the agent, the first level of criticality of the first update operation with the reboot policy to determine a first reboot behavior;
transitioning, at the agent, an endpoint state to a first reboot state to actuate the first reboot behavior, wherein the first reboot state comprises one or more of an advised reboot state, a mandatory reboot state, or a critical reboot state; and
actuating, at the agent, the first reboot behavior using the first reboot state.

2. The method of claim 1, further comprising:
actuating, at the agent, the first reboot behavior when the first level of criticality for the first update operation is a highest level of criticality when compared to one or more additional levels of criticality for one or more additional update operations identified by the agent on the managed endpoint; and
pausing, at the agent, the first reboot behavior when the first level of criticality for the first update operation is not a highest level of criticality when compared to the one or more additional levels of criticality for the one or more additional update operations.

3. The method of claim 2, wherein:
the agent includes two or more engines and an engine management functionality;
the two or more engines are each associated with a management service implemented at the managed endpoint;
the first update operation is performed by a first engine of the two or more engines; and
the one or more additional update operations are performed by additional engines of the two or more engines.

4. The method of claim 1, wherein the first level of criticality comprises:
an advised level associated with the advised state actuating an advised reboot behavior;
a mandatory level associated the mandatory state actuating a mandatory reboot behavior; or
a critical level associated with the critical state actuating a critical reboot behavior.

5. The method of claim 1, wherein the first update operation includes installation of a first patch; and the first level of criticality is based on one or more of a criticality score of the first patch, a patch type of the first patch, or a vulnerability type of the first patch.

6. The method of claim 1, wherein the reboot policy further comprises:
associating the first level of criticality with an advised reboot behavior that includes deferring a reboot for a first period of time;
associating the first level of criticality with a mandatory reboot behavior that includes deferring the reboot for a second period of time; and
associating the first level of criticality with a critical reboot behavior that includes deferring the reboot for a third period of time,
wherein:
the first period of time is longer than the second period of time, and
the second period of time is longer than the third period of time.

7. The method of claim 1, further comprising:
identifying, at the agent, a second update operation associated with a second level of criticality, wherein the second level of criticality is based on metadata of the second update operation;
comparing, at the agent, the second level of criticality of the second update operation with the reboot policy to determine a second reboot behavior;
comparing, at the agent, the second level of criticality and the first level of criticality; and
updating, at the agent, the endpoint state to:
the first reboot state when the second level of criticality is not higher than the first level of criticality or when the second level of criticality is equal to the first level of criticality, or
a second reboot state when the first level of criticality is not higher than the second level of criticality.

8. The method of claim 1, further comprising:
providing, at the managed endpoint, information related to the first level of criticality associated with the first update operation;
receiving, at the agent, from a management device, a user preference for the first level of criticality associated with the first update operation; and
adjusting the first reboot behavior based on the user preference.

9. The method of claim 1, further comprising:
causing display, via a graphical user interface, information about one or more reboot options associated with the first update operation, wherein the information is based on the first level of criticality; and
receiving, via the graphical user interface, input for the one or more reboot options associated with the first update operation.

10. The method of claim 1, further comprising receiving, at the agent, a first update package from a management device, wherein the first update package includes instructions implemented to initiate the first update operation and the metadata of the first update operation.

11. The method of claim 10, wherein:
the agent includes two or more engines and an engine management module;
the two or more engines are each associated with a management service implemented at the managed endpoint; and
the reboot policy includes at least one policy instruction associated with each engine of the two or more engines.

12. The method of claim 11, wherein:
a first engine of the two or more engines performs the first update operation based on the first update package; and
the identifying the first update operation associated with the first level of criticality is performed by the engine management functionality of the agent.

13. The method of claim 1, further comprising receiving, at the agent, the reboot policy that is defined by a management device, wherein the reboot policy includes definitions update operation criteria that associate the first update operation with the advised reboot state, the mandatory reboot state, or the critical reboot state.

14. One or more non-transitory computer-readable media having encoded thereon programming code executable by one or more processors to perform or control performance of operations to automate software management of a managed endpoint, the operations comprising:
identifying, at an agent located on the managed endpoint, a reboot policy, wherein the reboot policy indicates one or more reboot behaviors initiated after update operations are performed at the managed endpoint;
identifying, at the agent, a first update operation associated with a first level of criticality based on metadata associated with an instruction implemented to locally perform the first update operation on the managed endpoint;
comparing, at the agent, the first level of criticality of the first update operation with the reboot policy to determine a first reboot behavior;
transitioning, at the agent, an endpoint state to a first reboot state to actuate the first reboot behavior, wherein the first reboot state comprises one or more of an advised reboot state, a mandatory reboot state, or a critical reboot state; and
actuating, at the agent, the first reboot behavior using the first reboot state.

15. The one or more non-transitory computer-readable media of claim 14, wherein the operations further comprise:
actuating, at the agent, the first reboot behavior when the first level of criticality for the first update operation is a highest level of criticality when compared to one or more additional levels of criticality for one or more additional update operations identified by the agent on the managed endpoint; and
pausing, at the agent, the first reboot behavior when the first level of criticality for the first update operation is not a highest level of criticality when compared to the one or more additional levels of criticality for the one or more additional update operations.

16. The one or more non-transitory computer-readable media of claim 14, wherein the operations further comprise:
associating the first level of criticality with an advised reboot behavior that includes deferring a reboot for a first period of time;
associating the first level of criticality with a mandatory reboot behavior that includes deferring the reboot for a second period of time; and
associating the first level of criticality with a critical reboot behavior that includes deferring the reboot for a third period of time,
wherein:
the first period of time is longer than the second period of time, and
the second period of time is longer than the third period of time.

17. The one or more non-transitory computer-readable media of claim 14, wherein the operations further comprise:
identifying, at the agent, a second update operation associated with a second level of criticality, wherein the second level of criticality is based on metadata of the second update operation;
comparing, at the agent, the second level of criticality of the second update operation with the reboot policy to determine a second reboot behavior;
comparing, at the agent, the second level of criticality and the first level of criticality; and
updating, at the agent, the endpoint state to:
the first reboot state when the second level of criticality is not higher than the first level of criticality or when the second level of criticality is equal to the first level of criticality, or
a second reboot state when the first level of criticality is not higher than the second level of criticality.

18. The one or more non-transitory computer-readable media of claim 14, wherein the operations further comprise:
providing, at the managed endpoint, information related to the first level of criticality associated with the first update operation;
receiving, at the agent, from a management device, a user preference for the first level of criticality associated with the first update operation; and
adjusting the first-update operation reboot behavior based on the user preference.

19. The one or more non-transitory computer-readable media of claim 14, wherein the operations further comprise:
causing display, via a graphical user interface, information about one or more reboot options associated with the first update operation, wherein the information is based on the first level of criticality; and
receiving, via the graphical user interface, input for the one or more reboot options associated with the first update operation.

20. The one or more non-transitory computer-readable media of claim 14, wherein the operations further comprise:
receiving, at the agent, a first update package from a management device, wherein the first update package includes instructions implemented to initiate the first update operation and the metadata of the first update operation; and
receiving, at the agent, the reboot policy that is defined by a management device, wherein the reboot policy includes definitions update operation criteria that associate the first update operation with the advised reboot state, the mandatory reboot state, or the critical reboot state.
